(19) United States
(12) Patent Application Publication
(10) Pub. No.: US 2026/0308027 A1
(43) Pub. Date: Oct. 8, 2026

(54) DERIVATIZED POLYAMINE POLYMERS FOR USE IN METAL SCAVENGING APPLICATIONS

(71) Applicant: BL TECHNOLOGIES, INC., Minnetonka, MN (US)

(72) Inventors: Edward Urankar, Minnetonka, MN (US); Ruslan Guliyev, Minnetonka, MN (US); Lisa Spagnola, Minnetonka, MN (US)

(21) Appl. No.: 19/481,414

(22) PCT Filed: Apr. 12, 2024
(86) PCT No.: PCT/US2024/024365

§ 371 Date: Nov. 4, 2025

Related U.S. Application Data
(60) Provisional application No. 63/464,231, filed on May 5, 2023.

(51) Int. Cl. C02F 1/68; C02F 101/20; C08G 73/02

(52) U.S. Cl. CPC C02F 1/683; C08G 73/022; C02F 2101/20

(57) ABSTRACT

Provided herein is a method of preparing a metal ion scavenger comprising adding an effective amount of a piperazine derivative to a polyamine and epihalohydrin condensation reaction. Further provided herein is a method of treating aqueous and non-aqueous streams comprising adding a metal ion scavenger prepared by adding an effective amount of a piperazine derivative to a polyamine and epihalohydrin condensation reaction to the aqueous and non-aqueous streams.

### CROSS REFERENCE TO RELATED APPLICATIONS

This application claims priority to U.S. Provisional Patent Application No. 63/464,231, filed on May 5, 2023, which is incorporated by reference herein in its entirety.

### BACKGROUND

The disclosed technology provides for methods for preparing polyamine prepolymer backbones for use in the production of metal ion scavengers and sequestrants. More specifically, the disclosed technology provides for methods for preparing polyamine prepolymer backbones for use in the production of polydithiocarbamate-based metal ion scavengers and sequestrants, comprising introducing an effective amount of a piperazine derivative into a polyamine and epihalohydrin condensation reaction.

Heavy metal pollution is an existing and growing worldwide problem. For example, wastewater issuing from waste treatment facilities, the chlor-alkali industry, the metal finishing industry, cooling tower blowdown, incinerator scrubbers, municipal water streams, oil refineries and from certain municipal landfills often presents a metal contamination problem. Similarly, the metal content of water exiting both or either of functional and abandoned mines is a significant environmental issue in geographical areas with a mining industry. In addition to aqueous process water and wastewater streams, non-aqueous hydrocarbon stream that are common in petroleum refining processes or petrochemical processes also contain significant levels of heavy metal content that needs to be reduced. Heavy metal ions can cause issues for the environment and their concentrations in water are regulated.

Different treatment techniques have been developed to remove either or both dissolved and suspended heavy metal ions from industrial liquid streams. One common practice in aqueous streams is to precipitate the bulk of the heavy metal contaminant as its metal hydroxide. For example, metal ions such as copper and lead are easily precipitated in this way, but the minimum concentration that can be obtained is limited by the finite solubility of the hydroxide complexes. The resulting effluent from the hydroxide precipitation may be treated with a metal scavenging agent to remove any trace metal contaminants to meet discharge regulations. These agents may be precipitants, adsorbents, or metal specific ion exchange resins. The metal scavenger precipitants may also be effective when added in the same step as the hydroxide precipitation. Typical compounds utilized as precipitating scavenging agents include sulfides. (thio)carbonates, alkyl dithiocarbamates, mercaptans, and polydithiocarbamates.

Water-soluble polymeric dithiocarbamate-based scavengers are well known in the industry for the removal of heavy metal ions from contaminated waters. These polymeric products have benefits in both their aquatic toxicity profile and ability to precipitate over smaller dithiocarbamate or other organo sulfide compounds. However, current prepolymer backbone materials, especially polyethyleneimines (PEI) are expensive and can fall short with removal of certain metal ions.

Thus, what is needed in the art are less costly backbone substitutes having improved treatment performance when converted into dithiocarbamate products.

### SUMMARY

The disclosed technology provides for methods of preparing polyamine prepolymer backbones for use in the production of metal ion scavengers and sequestrants comprising introducing an effective amount of a piperazine derivative into a polyamine and epihalohydrin condensation reaction.

Various aspects of the disclosed technology relate to a method of preparing a metal ion scavenger comprising adding an effective amount of a piperazine derivative to a polyamine and epihalohydrin condensation reaction.

In various aspects, the piperazine derivative may be aminoethyl piperazine, the polyamine may be polyethylene polyamine and the epihalohydrin may be epichlorohydrin.

In various aspects, the metal ion scavenger may be a transition metal scavenger, such as a dithiocarbamate.

In various aspects, the metal ion scavenger may be used to treat aqueous or non-aqueous streams.

Various aspects of the disclosed technology additionally relate to a method of preparing a polyamine prepolymer backbone comprising adding an effective amount of a piperazine derivative to a polyamine and epihalohydrin condensation reaction.

Various aspects of the disclosed technology further relate to a method of preparing a polyamine prepolymer backbone comprising reacting a piperazine derivative and a first portion of an epihalohydrin to form a first reaction mixture, adding a polyamine to the first reaction mixture to form a second reaction mixture; and adding a second portion of the epihalohydrin to the second reaction mixture.

### BRIEF DESCRIPTION OF THE FIGURES

Those of skill in the art will understand that the figures, described below, are for illustrative purposes only. The figures are not intended to limit the scope of the present teachings in any way.

FIG. 1 illustrates cobalt concentrations in the supernatant of a synthetic water sample treated with an embodiment of the metal ion scavenger of the disclosure.

FIG. 2 illustrates nickel concentrations in the supernatant of a synthetic water sample treated with an embodiment of the metal ion scavenger of the disclosure.

FIG. 3 illustrates zinc concentrations in the supernatant of a synthetic water sample treated with an embodiment of the metal ion scavenger of the disclosure.

FIG. 4 illustrates cobalt concentrations in the supernatant of a synthetic water sample treated with an embodiment of the metal ion scavenger of the disclosure.

FIG. 5 illustrates nickel concentrations in the supernatant of a synthetic water sample treated with an embodiment of the metal ion scavenger of the disclosure.

FIG. 6 illustrates zinc concentrations in the supernatant of a synthetic water sample treated with an embodiment of the metal ion scavenger of the disclosure.

### DETAILED DESCRIPTION OF EXEMPLARY EMBODIMENTS

The disclosed technology provides for a method for preparing polyamine prepolymer backbones for use in the production of metal ion scavengers and sequestrants. More specifically, the disclosed technology provides for a method of preparing polyamine prepolymer backbones for use in the production of metal ion scavengers and sequestrants comprising the step of introducing an effective amount of a piperazine derivative into a polyamine and epihalohydrin condensation reaction.

The disclosed technology provides for a design and synthesis method of a polyamine prepolymer backbone that is employed in the production of polyvalent metal ion sequestrants and/or scavengers. The polyamine prepolymer backbone may be designed and synthesized by introducing an effective amount of a piperazine derivative into a polyamine and epihalohydrin condensation reaction. Without being bound by theory, the piperazine content in the polyamine prepolymer backbone may contribute to the control of structure, branching, conformation, and solubility profile of the final metal ion sequestrant and/or scavenger product.

The disclosed technology further provides for a synthesis method of a polyamine polymer backbone that is easily controlled and highly cost efficient. It has been surprisingly discovered that the order of addition of the reactants, wherein the piperazine derivative is reacted with epihalohydrin prior to the addition of polyamine to the reaction vessel, affects the effectiveness of the prepolymer backbone synthesis process. If the order of the addition is not followed or the effective amount of the piperazine derivative and its ratio to epihalohydrin is altered the desired prepolymer backbone synthesis will not be optimal. In some aspects, when the polyamine polymer backbone prepared using the synthesis method of the disclosure is converted to a corresponding metal ion scavenger and/or sequestrant, i) improved sensitivity and affinity towards certain metal ions, ii) wider effective dosage ranges, and iii) desirable floc formation profile can be observed.

As used herein, the term “metal ion scavenger” or “metal ion sequestrant” may be understood to mean an organic compound or a polymer material capable of binding metal ions to form chelate structures. Examples of metal ion scavengers or sequestrants may include dithiocarbamate, polydithiocarbamate or other organo sulfide compounds.

As used herein, the term “an effective amount” may be understood to mean any amount of piperazine derivative that would be effective in imparting the desired properties on a final metal ion sequestrant and/or scavenger product.

As used herein, the term “aqueous stream” may be understood to mean process water used in industry, manufacturing processes, power generation and the like.

As used herein, the term “wastewater” may be understood to mean used water from any combination of domestic, industrial, commercial, or agricultural activities, surface runoff/storm water, and any sewer inflow or sewer infiltration.

As used herein, the term “non-aqueous stream” may be understood to mean non-aqueous hydrocarbon streams used in petroleum refining processes, petrochemical processes and the like.

In various aspects, the disclosed technology provides methods of preparing a polyamine prepolymer backbone comprising adding an effective amount of a piperazine derivative to a polyamine and epihalohydrin condensation reaction. The disclosed technology further provides metal ion scavengers comprising polyamine polymer backbones prepared by the methods of the disclosure.

In some aspects, the methods may comprise preparing a polyamine prepolymer backbone by reacting a piperazine derivative and a first portion of an epihalohydrin to form a first reaction mixture; adding a polyamine to the first reaction mixture to form a second reaction mixture; and adding a second portion of the epihalohydrin to the second reaction mixture.

Suitable piperazine derivatives may include any piperazine derivative capable of forming a prepolymer backbone together with a polyamine and an epihalohydrin. In various aspects, suitable piperazine derivatives may include soluble piperazine derivatives. In some aspects, suitable piperazine derivatives may include aminoethyl piperazine (AEP).

Suitable polyamines may include any polyamine compound capable of forming a prepolymer backbone together with a piperazine derivative and an epihalohydrin. In some aspects, suitable polyamine compounds may include polyethylene polyamines, such as ethylene diamine (EDA), diethylenetriamine (DETA), triethylenetetramine (TETA), tetraethylenepentamine (TEPA), pentaethylenehexamine (PEHA), hexaethyleneheptamine (HEHA), other higher amines, and mixtures thereof.

Suitable epihalohydrins may include any epihalohydrin compound capable of forming a prepolymer backbone together with a piperazine derivative and a polyamine. In some aspects, suitable epihalohydrin compounds may include epichlorohydrin, epibromohydrin, epifluorohydrin, or epiiodohydrin.

In various aspects, the methods of the disclosure may include adding the piperazine derivative and polyamine in a mole ratio of about 1:1 to about 1:5, or about 1:1, 1:2, 1:3, 1:4 or 1:5, or any value in between any of these ratios, or about 1:2.

In various aspects, the methods of the disclosure may include adding the polyamine and epihalohydrin in a total amine molar ratio to epihalohydrin of between 1:1 to about 1:1.35 or any value in between these ratios.

In various aspects, the disclosed technology provides for metal ion scavengers and/or sequestrants prepared using the methods of the disclosure. In some aspects, the metal ion scavengers and/or sequestrants may be transition metal ion scavengers and/or sequestrants, such as a polydithiocarbamate. In some aspects, the metal ion scavengers and/or sequestrants may be used to treat aqueous and non-aqueous streams. In some aspects, aqueous streams that may be treated with the metal ion scavengers and/or sequestrants of the disclosure may include process water, such as wastewater. In some aspects, non-aqueous streams that may be treated with the metal ion scavengers and/or sequestrants of the disclosure may include non-aqueous hydrocarbon streams, such as those used in petroleum refining processes, petrochemical processes and the like.

In various aspects, the disclosed technology further provides a method of preparing a metal ion scavenger and/or sequestrant comprising adding an effective amount of a piperazine derivative to a polyamine and epihalohydrin condensation reaction. In some aspects, the disclosed technology provides a method of preparing a polydithiocarbamate comprising the steps of preparing a polyamine prepolymer backbone by adding an effective amount of a piperazine derivative to a polyamine and epihalohydrin condensation reaction and reacting the prepolymer backbone with carbon disulfide.

In various aspects, the disclosed technology further provides a method of removing metal ions from aqueous and non-aqueous streams comprising adding to the aqueous and non-aqueous streams the metal ion scavengers and/or sequestrants prepared according to the methods of the disclosure. In various aspects, the metal ion scavenger and/or sequestrant may be added to the aqueous and non-aqueous streams in any amount that is effective for removing metal ions from the aqueous and non-aqueous streams. In some aspects, the metal ion scavenger and/or sequestrant may be added in an amount of about 0.1 ppm to about 10000 ppm, or about 0.1, 1, 10, 50, 100, 500, 1000, 1500, 2000, 2500, 3000, 3500, 4000, 4500, 5000, 5500, 6000, 6500, 7000, 7500, 8000, 8500, 9000, 9500 or 10000 ppm, or about 0.1 ppm to about 1000 ppm or about 0.1 ppm to about 500 ppm, or any amount in between any of these values.

In various aspects, the aqueous and non-aqueous streams treated with the metal ion scavengers and/or sequestrants of the disclosure may comprise a metal ion content within regulatory limits as understood by one of skill in the art. In various aspects, metal ions that may be removed from the aqueous and non-aqueous streams using the metal ion scavengers and/or sequestrants of the disclosure may include cadmium, cobalt, copper, nickel, zinc, mercury, and the like.

### EXAMPLES

The present technology will be further described in the following examples, which should be viewed as being illustrative and should not be construed to narrow the scope of the disclosed technology or limit the scope to any particular embodiments.

### Example 1

### AEP-EPI-TEPA Prepolymer Synthesis (1A)

A reaction kettle equipped with an agitator, thermometer and reflux condenser was charged with 62 gr of Deionized (DI) Water. 42 gr of Aminoethylpiperazine (AEP) was added to the kettle and the temperature was adjusted to or below 25° C. To the stirred solution, 60 gr of Epichlorohydrin (EPI) was pumped over 30 mins. at a constant flow rate and the reaction temperature was not allowed to exceed 30° C. After the completion of the EPI feed, tetraethylenepentamine (TEPA) solution (123 gr TEPA+103 gr DI Water) was added to the reaction kettle in portions over 5 mins. while maintaining the temperature between 35° C.-40° C. When the temperature stabilized below 40° C., 39 gr of EPI (2nd portion) was fed into the reaction kettle over 20 min (AEP:EPI:TEPA mol ratio 1:3.15:2). After completion of the EPI feed, the batch was heated to 88° C. over 30 mins. and was held at 88° C. for 3 hrs. Heating was then turned off and 99 gr of DI water was added to the product (adjusting solids content to about 50%). The product was allowed to cool to room temperature. Obtained viscous (dark) yellow product was used in the next reaction without any purification.

¹³C NMR: 70 ppm-35 ppm (aliphatic ¹³C nuclei in the backbone, —N-CH2CH2-N-CH2-CH(OH)—CH2-).

### Dithiocarbamate Functionalization of AEP-EPI-TEPA Prepolymer (AEP-EPI-TEPA-CS2) (1B)

93 gr of AEP-EPI-TEPA Prepolymer (50%) solution was diluted with 204 gr DI Water in a reactor that was equipped with an agitator, thermometer, and reflux condenser and was kept under N2 blanket. To this solution was added 52 gr of NaOH (50%) over 20 mins. Light yellow colored solution was cooled to 38° C. before the Carbon Disulfide (CS2) feed was initiated. 43.55 gr CS2 (34.4 mL) was continuously fed to the reactor at a constant pace over 90 mins., whereas the temperature was gradually increased up to 43° C. over the course of the addition. After completion of the CS2 feed, the reaction was kept at 44° C. for 90 mins., and at 47-50° C. for an additional 30 mins. until the bright orange to red product was obtained (29.57% solids content). The product was packed under N2.

¹³C NMR: 211 ppm (N—CS2); 70 ppm-40 ppm (aliphatic ¹³C nuclei in the backbone)

### Example 2

### AEP-EPI-E100 Prepolymer Synthesis (2A)

A reaction kettle equipped with an agitator, thermometer and reflux condenser was charged with 62 gr of Deionized (DI) Water. 42 gr of AEP was added to the kettle and the temperature was adjusted to or below 25° C. To the stirred solution, 60 gr of EPI was pumped over 30 mins. at a constant flow rate and the reaction temperature was not allowed to exceed 30° C. After the completion of the EPI feed, E100 (mixture of TEPA, PEHA and HEHA) solution (179 gr E100+160 gr DI Water) was added to the reaction kettle in portions over 5 mins. while maintaining the temperature between 35° C.-40° C. When the temperature stabilized below 40° C., 39 gr of EPI (2nd portion) was fed into the reaction kettle over 20 min (AEP:EPI:E100 mol ratio 1:3.15:2). After completion of the EPI feed, the batch was heated to 88° C. over 30 mins. and was held at 88° C. for 3 hrs. Then heating was turned off and 98 Gr of DI water was added to the product (adjusting solids content to about 50%) and it was allowed to cool to room temperature. Obtained viscous (dark) yellow product was used in the next reaction without any purification.

### Dithiocarbamate Functionalization of AEP-EPI-E100 Prepolymer (AEP-EPI-E100-CS2) (2B)

AEP-EPI-E100 Prepolymer (50%) solution (86 gr) was diluted with 190 gr DI Water in a reactor that was equipped with an agitator, thermometer, reflux condenser and was kept under N2 blanket. To this solution was added 63 gr of NaOH (50%) over 20 mins. Light yellow colored solution was cooled to 38° C. before the Carbon Disulfide (CS2) feed was initiated (Prepolymer:CS2 mol ratio 1:6.5-8.1). 48 gr CS2 (38 mL) was continuously fed to the reactor at a constant pace over 90 mins., whereas the temperature was gradually increased up to 43° C. over the course of the addition. After completion of the CS2 feed, the reaction was kept at 44° C. for 90 mins., and at 47-50° C. for additional 30 mins. until the slightly hazy red product was obtained (31.7% solids content). The product was packed under N2 and became more clear red solution upon storage.

¹³C NMR: 210 ppm (N—CS2); 75 ppm-40 ppm (aliphatic ¹³C nuclei in the backbone)

### Example 3

### TEPA-EPI Prepolymer Synthesis (3A)

A reaction kettle equipped with an agitator, thermometer and reflux condenser was charged 300 gr of Deionized (DI) Water. 300 gr of TEPA was slowly added to the kettle and the temperature was maintained below 40° C. To the stirred solution, 191 gr of EPI was pumped over 90 mins. at a constant flow rate (TEPA:EPI mol ratio 1:1.2-1.35). The reaction temperature was not allowed to exceed 43° C. and was maintained between 37° C.-43° C. during the EPI feed. After completion of the EPI feed, the batch was heated to 88° C. over 30 mins. and was held at 88° C. for 3 hrs. Then heating was turned off and 191 gr of DI water was added to the product (adjusting solids content to about 50%) and it was allowed to cool to room temperature. Obtained viscous (dark) yellow product was used in the next reaction without any purification.

¹³C NMR: 70 ppm-35 ppm (aliphatic ¹³C nuclei in the backbone, —N-CH2CH2-N-CH2-CH(OH)—CH2-)

### Dithiocarbamate Functionalization of TEPA-EPI Prepolymer (TEPA-EPI-CS2) (3B)

87.3 gr of TEPA-EPI Prepolymer (50%) solution was diluted with 307.5 gr of DI Water in a reactor that was equipped with an agitator, thermometer, reflux condenser, and was kept under N2 blanket. To this solution was added 56.4 gr of NaOH (50%) over 20 mins. Light yellow colored solution was cooled to 38° C. before the Carbon Disulfide (CS2) feed was initiated (Copolymer:CS2 mol ratio 1:4.5-5.1). 48.8 gr CS2 (83.3 mL) was continuously fed to the reactor at a constant pace over 90 mins., whereas the temperature was gradually increased up to 43° C. over the course of the addition. After completion of the CS2 feed, the reaction was kept at 44° C. for 90 mins., and at 47-50° C. for additional 30 mins. until the slightly hazy orange to red product was obtained (24.16% solids content). The product was packed under N2 and became a more clear orangish red solution upon storage.

¹³C NMR: 210 ppm (N—CS2); 75 ppm-40 ppm (aliphatic ¹³C nuclei in the backbone)

### Example 4

### Premix (AEP+TEPA)—EPI Prepolymer Synthesis (4A)

A reaction kettle equipped with an agitator, thermometer and reflux condenser was charged 165 gr of Deionized (DI) Water. 42 gr of AEP and 123 Gr of TEPA was slowly added to the kettle and the temperature was maintained below 40° C. To the stirred solution 99 gr of Epichlorohydrin (EPI) was pumped over 90 mins. at a constant flow rate (AEP:TEPA:EPI mol ratio 1:2:3.15). The reaction temperature was not allowed to exceed 43° C. and was maintained between 37° C.-43° C. during the EPI feed. After completion of the EPI feed, the batch was heated to 88° C. over 30 mins. and was held at 88° C. for 3 hrs. Then heating was turned off and 99 gr of DI water was added to the product (adjusting solids content to about 50%) and it was allowed to cool to room temperature. Obtained viscous (dark) yellow product was used in the next reaction without any purification.

¹³C NMR: 70 ppm-35 ppm (aliphatic ¹³C nuclei in the backbone, —N-CH2CH2-N-CH2-CH(OH)—CH2-)

### Dithiocarbamate of (AEP+TEPA)-EPI Prepolymer (AEP+TEPA)-EPI-CS2 (4B)

76.5 gr of AEP-TEPA-EPI Prepolymer (50%) solution was diluted with 118.6 gr DI Water in a reactor that was equipped with an agitator, thermometer, reflux condenser and was kept under N2 blanket. To this solution was added 40.5 gr of NaOH (50%) over 20 mins. Light yellow colored solution was cooled to 38° C. before the Carbon Disulfide (CS2) feed was initiated. 35.8 gr of CS2 (28.3 mL) was continuously fed to the reactor at a constant pace over 90 mins., whereas the temperature was gradually increased up to 43° C. over the course of the addition. After completion of the CS2 feed, the reaction was kept at 44° C. for 90 mins., and at 47-50° C. for an additional 30 mins. until the bright orange to red product was obtained (34.75% solids content). The product was packed under N2.

¹³C NMR: 211 ppm (N—CS2); 70 ppm-40 ppm (aliphatic ¹³C nuclei in the backbone)

### Example 5

### E100-EPI Prepolymer Synthesis (5A)

A reaction kettle equipped with an agitator, thermometer and reflux condenser was charged 300 gr of Deionized (DI) Water. 300 gr of E100 (mixture of TEPA, PEHA and HEHA) was slowly added to the kettle and the temperature was maintained below 40° C. To the stirred solution, 137 gr of EPI was pumped over 90 mins. at a constant flow rate (E100:EPI mol ratio 1:1.2-1.35). The reaction temperature was not allowed to exceed 43° C. and was maintained between 37° C.-43° C. during the EPI feed. After completion of the EPI feed, the batch was heated to 88° C. over 30 mins. and was held at 88° C. for 3 hrs. Then heating was turned off and 137 gr of DI water was added to the product (adjusting solids content to about 50%) and it was allowed to cool to room temperature. Obtained viscous (dark) yellow product was used in the next reaction without any purification.

¹³C NMR: 70 ppm-35 ppm (aliphatic ¹³C nuclei in the backbone, —N-CH2CH2-N-CH2-CH(OH)—CH2-)

### Dithiocarbamate Functionalization of E100-EPI Prepolymer (E100-EPI-CS2) (5B)

E100-EPI Prepolymer (50%) solution (77 gr) was diluted with 134.3 gr of DI Water in a reactor that was equipped with an agitator, thermometer, reflux condenser and was kept under N2 blanket. To this solution was added 55.7 gr NaOH (50%) over 20 mins. Light yellow colored solution was cooled to 38° C. before the Carbon Disulfide (CS2) feed was initiated (Prepolymer:CS2 mol ratio 1:6.5-8.1). 49 gr of CS2 (38.7 mL) was continuously fed to the reactor at a constant pace over 90 mins., whereas the temperature was gradually increased up to 43° C. over the course of the addition. After completion of the CS2 feed, the reaction was kept at 44° C. for 90 mins., and at 47-50° C. for additional 30 mins. until the slightly hazy red product was obtained (36.5% solids content). The product was packed under N2 and became a clear red solution upon storage.

¹³C NMR: 210 ppm (N—CS2); 75 ppm-40 ppm (aliphatic ¹³C nuclei in the backbone)

Various properties of the dithiocarbamate polymers of Examples 1-5 are shown below in Table 1.

TABLE 1

| | | | | Ratio of carbons |
|---|---|---|---|---|
| | | | | (210 ppmshift/sum |
| | | | | 40-80 ppm shifts) |
| | Mw | Mn | Mw/Mn | *100 |
| Example 1 | 16,990 | 5,882 | 2.9 | 22.01 |
| Example 2 | 11,350 | 4,268 | 2.66 | 23.66 |
| Example 3 | 17,830 | 4,264 | 4.18 | 25.03 |
| Example 4 | 9,307 | 4,531 | 2.05 | 22.72 |
| Example 5 | 37,960 | 7,558 | 5.02 | 23.25 |

### Example 6

Metals Removal from Synthetic Water

Hard and Soft (Lewis) Acid and Base classifications classify compounds as hard or soft acids and hard or soft bases. Unbound ionic metals are Lewis acids as they are able to accept electron pairs from donors (Lewis bases). Depending on electron orbital structure, charge, and size they can be hard, soft or intermediate. Alkali and alkali earth metal ions are considered hard acids while transition metal ions are typically soft or intermediate. Since transition metals can cause issues for the environment and public health, their concentration in water is regulated. Since like reacts with like, soft bases such as sulfur-containing compounds and/or ligands (dithiocarbamates and trithiocarbonates) are typically used to remove these metals by physical-chemical separation. Due to their lower toxicity, highly functionalized polyamine-based polymers comprising dithiocarbamate functionalities are preferred over small molecules.

Still these products can fall short with removal of the intermediate acid metals such as cobalt, nickel and zinc.

In this Example, synthetic water was created with approximately 1.2 ppm of Cd+2, Co+2, Cu+2, Ni+2, Zn+2. To create the synthetic water HEPES buffer was dissolved into deionized water so that the final solution was 0.01 N HEPES. Stock solutions of chloride salts were then added to the buffered water to achieve the desired amount of metal ion. The water was then adjusted to pH 8 slowly with 1N NaOH.

250 mL aliquots of the synthetic water were tested using a standard jar tester. The metals removal product, i.e, of Examples 1-5, was dosed into the jar while mixing at 100 rpm. Two minutes was allowed to elapse before the mixing was reduced to 35 rpm. After 5 minutes the mixing was stopped, and the jars were allowed to settle for an additional 5 minutes. Samples of the supernatant were removed for ICP analysis of the remaining metals. Metals concentration of the supernatant was measured for unfiltered (total) and 0.45 micron filtered samples (soluble).

The percent removal from the supernatant and percent soluble metal removal after addition of the metal removal products of Examples 1-5 are shown below in Tables 2 and 3.

TABLE 2
Polymers with TEPA

| | Percent Removal from Supernatant | | | | Percent Soluble Metal Removal | | | |
|---|---|---|---|---|---|---|---|---|
| | Industrial | Example | Example | Example | Industrial | Example | Example | Example |
| | Standard | 1B | 3B | 4B | Standard | 1B | 3B | 4B |
| cadmium | 82.0 | 90.3 | 87.7 | 88.1 | 99.5 | 99.5 | 99.5 | 99.5 |
| cobalt | 75.0 | 89.1 | 84.4 | 83.6 | 99.1 | 99.1 | 99.1 | 99.1 |
| copper | 83.3 | 91.2 | 90.4 | 90.4 | 97.4 | 97.4 | 97.4 | 97.4 |
| nickel | 75.2 | 87.9 | 84.9 | 78.0 | 99.5 | 97.8 | 99.5 | 99.5 |
| zinc | 57.6 | 76.6 | 76.3 | 62.1 | 76.8 | 95.2 | 87.7 | 97.8 |

TABLE 3
Polymers with E100

| | Percent Removal from Supernatant | | | Percent Soluble Metal Removal | | |
|---|---|---|---|---|---|---|
| | Industrial | Example | Example | Industrial | Example | Example |
| | Standard | 2B | 5B | Standard | 2B | 5B |
| cadmium | 83.2 | 89.5 | 81.0 | 99.5 | 99.5 | 99.5 |
| cobalt | 50.9 | 89.3 | 49.1 | 72.3 | 99.1 | 99.1 |
| copper | 85.5 | 90.6 | 82.9 | 97.7 | 97.7 | 97.7 |
| nickel | 53.3 | 89.7 | 45.4 | 70.5 | 99.6 | 99.6 |
| zinc | 23.2 | 83.6 | 35.9 | 49.4 | 92.4 | 98.6 |

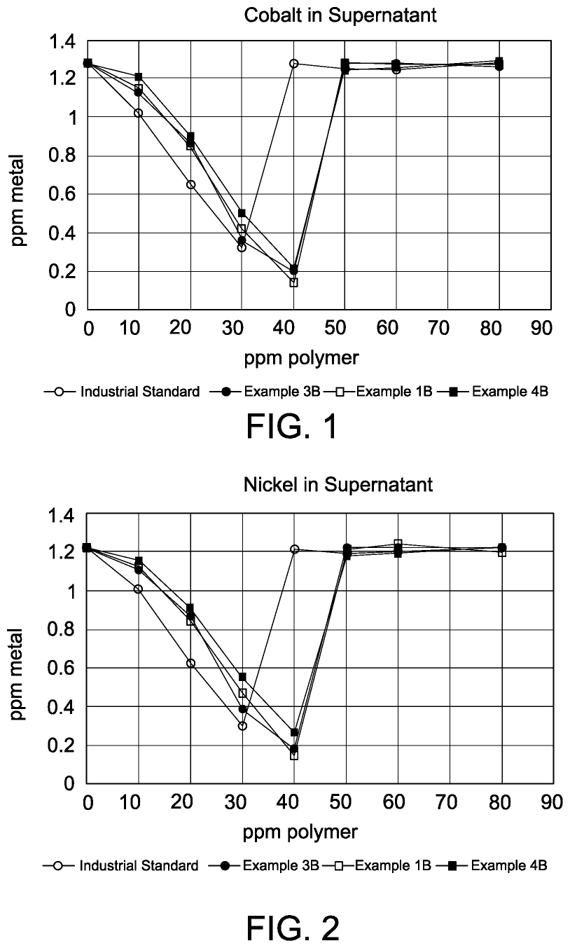

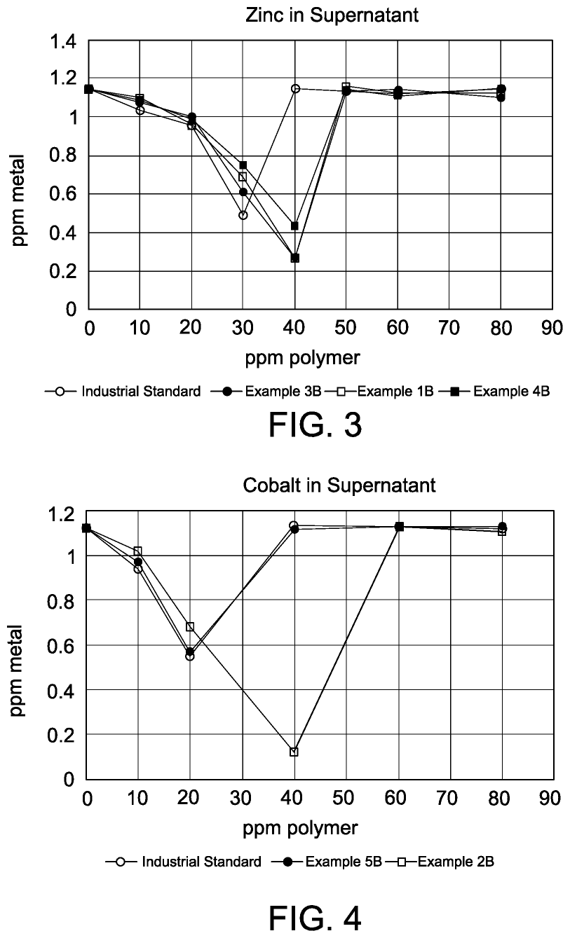

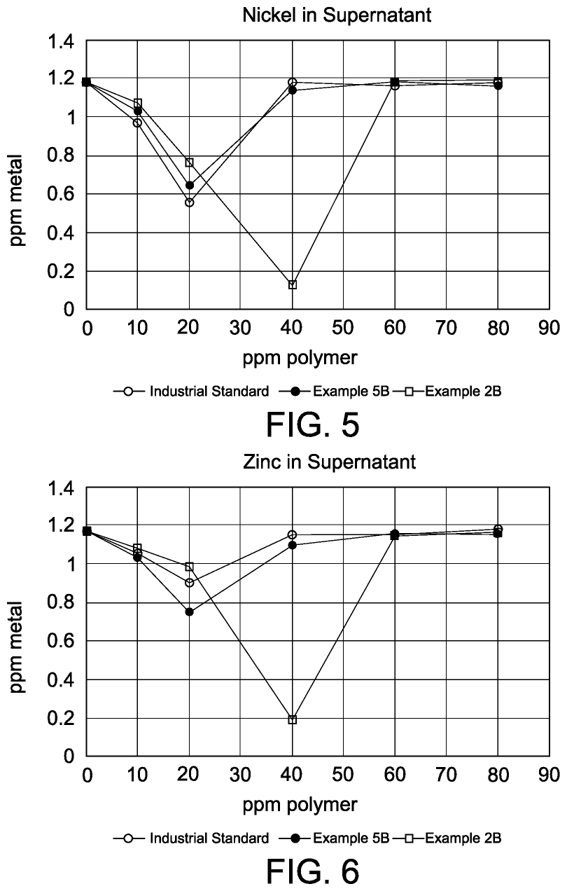

As shown in Tables 2 and 3, and FIGS. 1-6, by changing the polyamine-based polymer backbone and controlling the structure, the ability for the polymers of the disclosure, to remove metals such as cobalt, nickel and zinc can be improved both in percent removal and operating window.

More specifically, as shown in FIGS. 1-3, the dithiocarbamate polymer of Example 1B showed improved removal of cobalt, nickel and zinc when compared to the control polymer of Example 3B and the comparative polymer of Example 4B, as well as the industrial standard. Similarly, the dithiocarbamate polymer of Example 2B showed improved removal of cobalt, nickel and zinc when compared to the control polymer of Example 5B, as well as the industrial standard.

Furthermore, as shown in Tables 2 and 3, the dithiocarbamate polymer of Example 1B showed improved and/or comparable removal of cadmium and copper when compared to the control polymer of Example 3B and the comparative polymer of Example 4B, as well as the industrial standard. The dithiocarbamate polymer of Example 2B also showed improved and/or comparable removal of cadmium and copper when compared to the control polymer of Example 5B, as well as the industrial standard.

While embodiments of the disclosed technology have been described, it should be understood that the present disclosure is not so limited, and modifications may be made without departing from the disclosed technology. The scope of the disclosed technology is defined by the appended claims, and all devices, processes, and methods that come within the meaning of the claims, either literally or by equivalence, are intended to be embraced therein.

1-6. (canceled)

7. A metal ion scavenger comprising a polyamine prepolymer backbone, wherein the polyamine prepolymer backbone is prepared by adding an effective amount of a piperazine derivative to a polyamine and epihalohydrin condensation reaction.

8. The metal ion scavenger of claim 7, wherein the metal ion scavenger is a transition metal ion scavenger.

9. The metal ion scavenger of claim 8, transition metal ion scavenger is a dithiocarbamate.

10. A method of removing metal ions from aqueous or non-aqueous streams comprising adding the metal ion scavenger of claim 7.

11. The method of claim 10, wherein the aqueous streams comprise wastewater.

12. The method of claim 10, wherein the metal ions are selected from the group consisting of cadmium, cobalt, copper, nickel, zinc, mercury and mixtures thereof.

13. The method of claim 10, wherein the metal ion scavenger is added in an amount of about 0.1 ppm to about 1000 ppm.

14. (canceled)

15. A method of preparing a metal ion scavenger comprising adding an effective amount of a piperazine derivative to a polyamine and epihalohydrin condensation reaction.

16. The method of claim 15, wherein the method comprises at least one of: (a) the piperazine derivative is aminoethyl piperazine; (b) the polyamine is a polyethylene polyamine; and (c) the epihalohydrin is epichlorohydrin.

17. (canceled)

18. (canceled)

19. The method of claim 15, wherein the metal ion scavenger is a transition metal ion scavenger.

20. The method of claim 19, wherein the transition metal ion scavenger is a dithiocarbamate.

21. A method of preparing a polyamine prepolymer backbone comprising
reacting a piperazine derivative and a first portion of an epihalohydrin to form a first reaction mixture;
adding a polyamine to the first reaction mixture to form a second reaction mixture; and
adding a second portion of the epihalohydrin to the second reaction mixture.

22. The method of claim 21, wherein the method comprises at least one of: (a) the piperazine derivative is aminoethyl piperazine; (b) the polyamine is a polyethylene polyamine; and (c) the epihalohydrin is epichlorohydrin.

23. (canceled)

24. (canceled)

25. The method of claim 21, wherein the piperazine derivative and the polyamine are added in a molar ratio of about 1:1 to about 1:5.

26. (canceled)

27. A metal ion scavenger comprising the polyamine prepolymer backbone prepared according to the method of claim 21.

28. The metal ion scavenger of claim 27, wherein the metal ion scavenger is a transition metal ion scavenger.

29. The metal ion scavenger of claim 28, transition metal ion scavenger is a dithiocarbamate.

30. A method of removing metal ions from aqueous or non-aqueous streams comprising adding the metal ion scavenger prepared of claim 27.

31. The method of claim 30, wherein the aqueous streams comprise wastewater.

32. The method of claim 30, wherein the metal ions are selected from the group consisting of cadmium, cobalt, copper, nickel, zinc, mercury, and mixtures thereof.

33. (canceled)

34. (canceled)
